(19) United States
(12) Patent Application Publication
(10) Pub. No.: US 2011/0171589 A1
(43) Pub. Date: Jul. 14, 2011

(54) SINTERING FURNACE FOR CERAMIC PRODUCT AND SINTERING METHOD USING THE SAME

(75) Inventors: Mun Su HA, Suwon (KR); Doo Young KIM, Yongin (KR); Chul Seung LEE, Seoul (KR)

(73) Assignee: SAMSUNG ELECTRO-MECHANICS CO., LTD.

(21) Appl. No.: 13/005,842

(22) Filed: Jan. 13, 2011

(30) Foreign Application Priority Data
Jan. 14, 2010 (KR) 10-2010-0003386

(51) Int. Cl. F27B 14/00; F27B 21/00

(52) U.S. Cl. 432/13; 432/200

(57) ABSTRACT

There is provided a sintering furnace for a ceramic product and a sintering method using the same. A sintering furnace for a ceramic product according to an aspect of the invention may include: a furnace body having an insulating material provided therein; at least one setter arranged in the furnace body and having a ceramic molded product loaded on an upper side thereof; a heater supplying heat to the ceramic molded product; and a gas supply device disposed under the setter or around the heater so that a uniform temperature gradient is maintained inside the furnace body.

According to an aspect of the invention, there is provided a sintering furnace for a ceramic product and a sintering method using the same that can prevent changes in the characteristics of a ceramic product by a temperature gradient during sintering by reducing temperature variations inside a sintering furnace.

### CROSS-REFERENCE TO RELATED APPLICATIONS

This application claims the priority of Korean Patent Application No. 10-2010-0003386 filed on Jan. 14, 2010, in the Korean Intellectual Property Office, the disclosure of which is incorporated herein by reference.

### BACKGROUND OF THE INVENTION

1. Field of the Invention

The present invention relates to a sintering furnace for a ceramic product and a sintering method using the same, and more particularly, to a sintering furnace for a ceramic product and a sintering method using the same that can prevent changes in the characteristics of a ceramic product caused by a temperature gradient during sintering by reducing temperature variations inside a sintering furnace.

2. Description of the Related Art

Recently, the development of chip type ceramic components focused on reducing the size thereof and maximizing the capacity thereof has led to a reduction of the thickness of a dielectric or an internal electrode to a 1 μm or less, and an increase of the number of laminations. Since these chip type ceramic components are highly likely to become defective during plasticizing or sintering, the importance of development in the area of heat treatment techniques or equipment used therefor has grown.

In particular, since an internal electrode needs to be thinned, substrate powder being used in the internal electrode necessarily has particles less than 100 nm. As substrate powder has smaller particles, it is highly likely to undergo oxidization occurring at low temperature or cause poor connection due to the aggregation of the internal electrode. In order to prevent these problems, it is important to coincide a sintering initiation temperature of a dielectric with a sintering initiation temperature of an internal electrode. To this end, there is a typical method of delaying the sintering of an internal electrode through a rapid temperature rise.

Typical sintering furnaces being manufactured using mass production are divided into batch type sintering furnaces and tunnel type sintering furnaces, according to structure thereof. Tunnel type sintering furnaces are divided into push type sintering furnaces and roller type sintering furnaces, according to a method of putting a ceramic molded product into a sintering furnace.

A batch type sintering furnace is desirable when sintering chip type ceramic components having various sizes and characteristics in that the batch type sintering furnace allows for the application of a variety of sintering conditions. However, since a rapid temperature rise is limited, it is difficult to obtain the structural stabilization of the internal electrodes of chip type ceramic components. On the other hand, as for a tunnel type sintering furnace, since a sintering product is moved between heaters heating at a predetermined temperature by a pusher or a roller, the tunnel type sintering furnace is excellent in terms of having a stabilized atmosphere and temperature in the interior thereof. However, it is difficult to apply various sintering conditions. In light of the future development of chip type ceramic components, batch type sintering furnaces capable of applying various sintering conditions are suitable, and thus it is required that batch type sintering furnaces produce a rapid temperature rise.

In general, while a batch type sintering furnace has a plurality of heaters arranged along the inner walls of a cylindrical sintering furnace, a sintering product is located at the center of the sintering furnace so that the sintering product is slightly separated from the heaters. A heating source being generated from the heaters is transferred to the sintering product by convection currents or radiation. Since the sintering product is slightly separated from the heaters, heat generated from the heaters is transferred by convection currents, and thermal efficiency decreases according to distance. As a result, the heat cannot be directly transferred to the sintering product as compared with heat transfer by radiation. Therefore, it is difficult to perform a rapid temperature rise. In the same manner, it is also difficult to achieve rapid cooling due to the latent heat of an insulating material that surrounds the inside of the sintering furnace.

### SUMMARY OF THE INVENTION

An aspect of the present invention provides a sintering furnace for a ceramic product and a sintering method using the same that can prevent the changes in the characteristics of a ceramic product due to a temperature gradient during sintering by reducing temperature variations inside the sintering furnace.

According to an aspect of the present invention, there is provided a sintering furnace for a ceramic product, the sintering furnace including: a furnace body having an insulating material provided therein; at least one setter arranged in the furnace body and having a ceramic molded product loaded on an upper side thereof; a heater supplying heat to the ceramic molded product; and a gas supply device disposed under the setter or around the heater so that a uniform temperature gradient is maintained inside the furnace body.

The gas supply device may supply atmospheric gas or cooling gas.

The gas supply device may supply at least one selected from gases including nitrogen, hydrogen, and oxygen.

The gas supply device may have gas supply holes arranged at predetermined intervals in order to uniformly supply gas to the furnace body.

The gas supply device, disposed under the setter, may serve as a support for the setter and the ceramic molded product.

The sintering furnace may further include an exhaust pipe disposed at an upper side of the insulating material.

According to another aspect of the present invention, there is provided a sintering method using a sintering furnace for a ceramic product, the sintering method including: preparing a furnace body having an insulating material provided therein; arranging at least one setter inside the furnace body; loading a ceramic molded product on the setter; disposing a heater around the ceramic molded product; disposing a gas supply device under the setter or around the heater so that a uniform temperature gradient is maintained inside the furnace body; and sintering the ceramic molded product.

The gas supply device may supply atmospheric gas or cooling gas.

The gas supply device may supply at least one selected from gases including nitrogen, hydrogen, and oxygen.

The gas supply device may have gas supply holes arranged at predetermined intervals in order to uniformly supply gas to the furnace body.

The gas supply device, disposed under the setter, may serve as a support for the setter and the ceramic molded product.

The sintering method may further include disposing an exhaust pipe at an upper side of the insulating material.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically illustrating a sintering furnace for a ceramic product according to an exemplary embodiment of the present invention; and

FIG. 2 is a flowchart schematically illustrating a sintering process of a ceramic product using a sintering furnace for a ceramic product according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

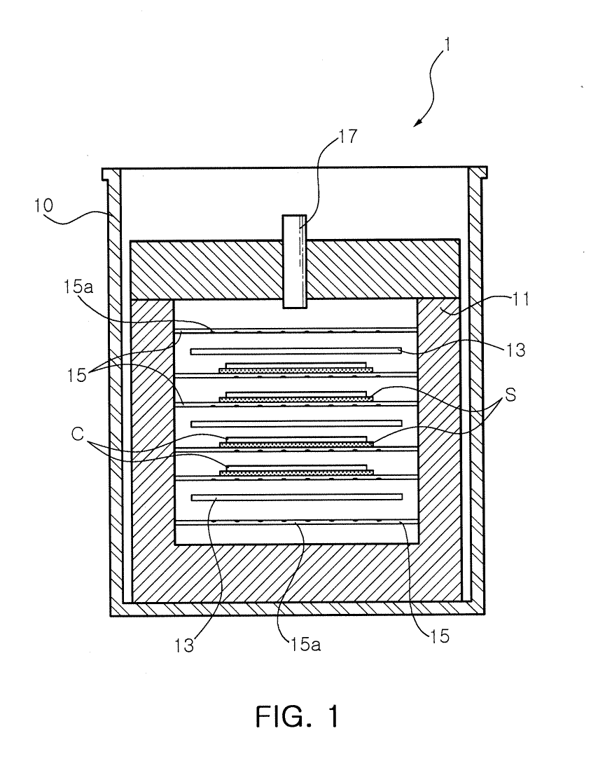

Hereinafter, a sintering furnace according to an exemplary embodiment of the invention will be described with reference to FIG. 1.

FIG. 1 is a cross-sectional view schematically illustrating a sintering furnace for a ceramic product according to an exemplary embodiment of the invention.

A sintering furnace for a ceramic product (hereinafter, simply referred to as a sintering furnace 1) according to this embodiment may include a furnace body 10, setters S, heaters 13, and gas supply devices 15. The furnace body 10 has an insulating material 11 provided therein. The setters S are arranged inside the furnace body 10 and have the ceramic molded products C loaded on upper surfaces thereof. The heaters 13 supply heat to the ceramic molded products C. The gas supply devices 15 may be arranged under the setters S or around the heaters 13 so that a uniform temperature gradient may be maintained inside the furnace body 10. Also, the sintering furnace for a ceramic product according to this embodiment may further include an exhaust pipe 17 that is disposed at an upper side of the insulating material 11.

The insulating material 11 has walls formed of an alumina-based ceramic fiber board and a bottom formed of thermal insulation of mullite refractories. The plurality of heaters 13 are formed through the walls of the insulating material 11 and are coupled thereto, so that the inside of the insulating material 11, which corresponds to a sealed chamber type, is heated at a temperature of up to approximately 800° C. to 1700° C. by the heaters 13. Here, the materials forming the insulating material 11 are not limited thereto.

Furthermore, the setters S having the ceramic molded products C located on the upper surfaces thereof are arranged inside the insulating material 11. The exhaust pipe 17 is disposed at the center of the upper side of the insulating material 11 to thereby exhaust binders containing organic materials generated during sintering. In this embodiment, the exhaust pipe 17 being disposed at the upper side of the insulating material 11 is exemplified. However, the location of the exhaust pipe 17 is not limited thereto, and various designs thereof can be made according to user's demand.

Here, the gas supply devices 15 are disposed under the setters S or around the heaters 13. The gas supply devices 15 have gas supply holes 15a arranged at predetermined intervals in order to uniformly supply gas to the furnace body 10.

The gas supply devices 15 supply atmospheric gas or cooling gas. The gas supply devices 15 may supply at least one selected from gases such as nitrogen, hydrogen, and oxygen.

Here, the gas supply devices 15, located under the setters S, may serve as mounts stably supporting the setters S and the ceramic molded products C and serve to reduce heat being supplied from the heaters 13.

Furthermore, the gas supply devices 15, disposed around the heaters 13, may serve to reduce heat being supplied from the heaters 13.

The sintering shrinkage initiation of the ceramic molded products C, disposed adjacent to the heaters 13, occurs earlier than that of the ceramic molded products C, relatively distant from the heaters 13. Therefore, inconsistency of sintering shrinkage initiation between the ceramic molded products C adjacent to the heaters 13 and the ceramic molded products C relatively distant from the heaters 13 may cause distortions such as bending, twisting or cracks in the ceramic molded products C.

In order to solve these problems, it is important to match sintering shrinkage initiation temperatures regardless of the distance between the ceramic molded products C and the heaters 13. A rapid temperature rise is typically used to match sintering shrinkage initiation temperatures.

As described above, a general batch type sintering furnace has a plurality of heaters arranged along the inner walls of a cylindrical sintering furnace. Since a sintering product is located at the center of the sintering furnace, the heaters are slightly separated from the sintering product. Here, a heat source generated from the heaters is transferred to the sintering product by convection currents or radiation. Since the heaters are slightly separated from the sintering product, heat generated from the heaters is generally transferred by convection currents, and the thermal efficiency decreases according to distance. As a result, as compared with heat transfer by radiation, heat cannot be directly transferred to the sintering product, which makes it difficult to produce a rapid temperature rise. A general batch type sintering furnace has a heating rate of approximately 20° C./min. Furthermore, it is also difficult to achieve rapid cooling due to the latent heat of the insulating material surrounding the inside of the sintering furnace.

On the contrary, according to this embodiment, as the gas supply devices 15 are arranged under the setters S being multilayered or around the heaters 13, a uniform temperature gradient can be maintained inside the furnace body 10, thereby compensating the above-described inconsistency of sintering shrinkage initiation. As a result, the above-described distortions that may occur in the ceramic molded products C can be prevented.

The sintering furnace is designed in such a manner that the plurality of heaters 13 are densely arranged in the furnace body 10 at predetermined intervals, the setters S are located between the heaters 13, and the ceramic molded products C are located on the setters S so that heat generated from the heaters 13 can be directly transferred to the ceramic molded products C. The sintering furnace designed to have this structure is effective in terms of a rapid temperature rise because heat generated from the heaters 13 is directly transferred to the ceramic molded products C. The sintering furnace 1 according to this embodiment has a heating rate of 100° C./min or higher. Furthermore, since the arrangement of the gas supply devices 15 enables rapid cooling as the need arises, an additional cooling device is unnecessary. Also, since the heaters 13 and the setters S can be separated by predetermined intervals, reactions between the heaters 13 and the setters S can be reduced to thereby increase the durability of the heaters 13 and the setters S. Furthermore, the gas supply devices 15 may serve as mounts that stably support the setters S and the ceramic molded products C.

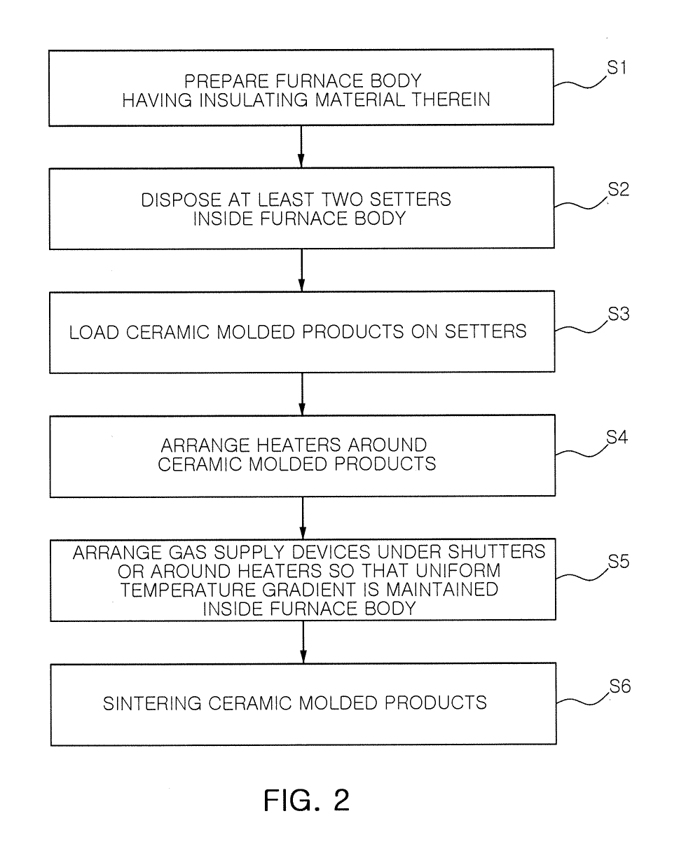

Hereinafter, a sintering process of a ceramic product using a sintering furnace for a ceramic product according to an exemplary embodiment of the invention will be described with reference to FIGS. 1 and 2.

FIG. 1 is a cross-sectional view schematically illustrating a sintering furnace for a ceramic product according to an exemplary embodiment of the invention. FIG. 2 is a flowchart illustrating a sintering process schematically illustrating a sintering process of a ceramic product using a sintering furnace for a ceramic product according to an exemplary embodiment of the invention.

According to a sintering method of a ceramic product using the sintering furnace for a ceramic product (also referred to as the sintering furnace 1) according to this embodiment, the furnace body 10 having the insulating material 11 provided therein is prepared in operation S1, the setters S are arranged inside the furnace body 10 in operation S2, the ceramic molded products C are loaded on the setters S in operation S3, the heaters 13 are arranged around the ceramic molded products C in operation S4, the gas supply devices 15 are arranged under the setters S and the around the heaters 13 so that a uniform temperature gradient is maintained inside the furnace body 10 in operation S5, and the ceramic molded products C are sintered in operation S6. According to the sintering method of a ceramic product using the sintering furnace 1, additionally, the exhaust pipe 17 may be disposed at the upper side of the insulating material 11.

First, the furnace body 10 having the insulating material 11 provided therein is prepared. Here, the insulating material 11 has walls formed of an alumina-based ceramic fiber board and a bottom formed of thermal insulation of mullite refractories. However, the materials forming the insulating material 11 are not limited thereto.

As the plurality of heaters 13 are formed through the walls of the insulating material 11 and are coupled with the insulating material 11, the inside of the insulating material 11, which corresponds to a sealed chamber type, is heated at a temperature of approximately 800° C. to 1700° C. by the heaters 13.

Then, the setters S are disposed inside the furnace body 10, and the ceramic molded products C are loaded on the setters S. Here, the setters S may be multilayered as the need arises.

Furthermore, the exhaust pipe 17 is disposed above the ceramic molded products C inside the insulating material 11 so that a binder containing organic materials, generated during sintering, and other impurities are exhausted to the outside.

Then, the gas supply devices 15 are arranged under the setters S or around the heaters 13. The gas supply devices 15 have the gas supply holes 15a arranged at predetermined intervals in order to uniformly supply gas to the furnace body 10.

The gas supply devices 15 supply atmospheric gas or cooling gas. The gas supply devices 15 may supply at least one selected from gases such as nitrogen, hydrogen, and oxygen.

Here, the gas supply devices 15 disposed under the setters S may serve as mounts stably supporting the setters S and the ceramic molded products C and serve to cool heat being supplied from the heaters 13.

Furthermore, the gas supply devices 15, disposed around the heaters 13, may cool heat generated from the heaters 13.

Finally, the ceramic molded products C are sintered. When the ceramic molded products C are sintered, a reflow process may be performed on active gas inside the insulating material 11 through the exhaust pipe 17 to thereby activate the sintering process.

The sintering shrinkage initiation of the ceramic molded products C, disposed adjacent to the heaters 13, occurs earlier than that of the ceramic molded products C relatively distant from the heaters 13. Therefore, inconsistency of sintering shrinkage initiation between the ceramic molded products C adjacent to the heaters 13 and the ceramic molded products C relatively distant from the heaters 13 may cause distortions such as bending, twisting or cracks, in the ceramic molded products C.

In order to solve these problems, it is important to match sintering shrinkage initiation temperatures regardless of the distance between the heaters 13 and the ceramic molded products C. A rapid temperature rise is typically used to match sintering shrinkage initiation temperatures.

As described above, a general batch type sintering furnace has a plurality of heaters arranged along the inner walls of a cylindrical sintering furnace. Since a sintering product is located at the center of the sintering furnace, the heaters are slightly separated from the sintering product. Here, a heat source generated from the heaters is transferred to the sintering product by convection currents or radiation. Since the heaters are slightly separated from the sintering product, heat generated from the heaters is generally transferred by convection currents, and the quantity of heat transferred decreases according to distance. Thus, as compared with heat transfer by radiation, heat cannot be directly transferred to the sintering product, which makes it difficult to produce a rapid temperature rise. A general batch type sintering furnace has a heating rate of approximately 20° C./min. Furthermore, it is also difficult to perform rapid cooling due to latent heat of insulating material surrounding the inside of the sintering furnace.

On the contrary, as the gas supply devices 15 are arranged under the setters S being multilayered or arranged around the heaters 13, a uniform temperature gradient can be maintained inside the furnace body 10, thereby compensating for the above-described inconsistency of sintering shrinkage initiation. As a result, the above-described distortions that may occur in the ceramic molded products C can be prevented.

The sintering furnace is designed in such a manner that the plurality of heaters 13 are densely arranged in the furnace body 10 at predetermined intervals, the setters S are located between the heaters 13, and the ceramic molded products C are located on the setters S so that heat generated from the heaters 13 can be directly transferred to the ceramic molded products C. The sintering furnace designed to have this structure is effective in terms of a rapid temperature rise since heat generated from the heaters 13 is directly transferred to the ceramic molded products C. The sintering furnace 1 according to this embodiment has a heating rate of 100+ C./min or higher. Furthermore, since the arrangement of the gas supply devices 15 enables rapid cooling as the need arises, an additional cooling device is unnecessary. Also, since the heaters 13 and the setters S can be separated by predetermined intervals, reactions between the heaters 13 and the setters S can be reduced to thereby increase the durability of the heaters 13 and the setters S. Furthermore, the gas supply devices 15 may serve as mounts stably supporting the setters S and the ceramic molded products C.

According to exemplary embodiments of the invention, there can be provided a sintering furnace for a ceramic product and a sintering method using the same that can prevent changes in the characteristics of a ceramic product caused by a temperature gradient by reducing temperature variations inside the sintering furnace.

Furthermore, since a uniform temperature gradient can be maintained inside the sintering furnace providing adequate supply of a heat source and cooling, it is possible to manufacture a single crystal ceramic product by rapid sintering without causing physical and chemical defects and does not form the remaining crystalline structure. Therefore, it is also possible to manufacture a ceramic product showing a few errors in a dielectric constant, resistivity, and capacitance. That is, it is possible to manufacture a ceramic product having excellent electrical characteristic, and a module thereof.

Since it is also possible to control a heating rate of a thick multilayer ceramic stack having a large area in a large-sized sintering furnace, the degree of freedom in designing high frequency modules, such as signal lines, ground, and power can be enhanced.

Furthermore, since debinding and solvent stripping are facilitated, and sintering, crystallization, and densification are also allowed regardless of position on a large board, a high-strength ceramic product can be manufactured while a sintered ceramic product is free from decolorization.

While the present invention has been shown and described in connection with the exemplary embodiments, it will be apparent to those skilled in the art that modifications and variations can be made without departing from the spirit and scope of the invention as defined by the appended claims.

What is claimed is:

1. A sintering furnace for a ceramic product, the sintering furnace comprising:
a furnace body having an insulating material provided therein;
at least one setter arranged in the furnace body and having a ceramic molded product loaded on an upper side thereof;
a heater supplying heat to the ceramic molded product; and
a gas supply device disposed under the setter or around the heater so that a uniform temperature gradient is maintained inside the furnace body.

2. The sintering furnace of claim 1, wherein the gas supply device supplies atmospheric gas or cooling gas.

3. The sintering furnace of claim 1, wherein the gas supply device supplies at least one selected from gases including nitrogen, hydrogen, and oxygen.

4. The sintering furnace of claim 1, wherein the gas supply device has gas supply holes arranged at predetermined intervals in order to uniformly supply gas to the furnace body.

5. The sintering furnace of claim 1, wherein the gas supply device, disposed under the setter, serves as a support for the setter and the ceramic molded product.

6. The sintering furnace of claim 1, further comprising an exhaust pipe disposed at an upper side of the insulating material.

7. A sintering method using a sintering furnace for a ceramic product, the sintering method comprising:
preparing a furnace body having an insulating material provided therein;
arranging at least one setter inside the furnace body;
loading a ceramic molded product on the setter;
disposing a heater around the ceramic molded product;
disposing a gas supply device under the setter or around the heater so that a uniform temperature gradient is maintained inside the furnace body; and
sintering the ceramic molded product.

8. The sintering method of claim 7, wherein the gas supply device supplies atmospheric gas or cooling gas.

9. The sintering method of claim 7, wherein the gas supply device supplies at least one selected from gases including nitrogen, hydrogen, and oxygen.

10. The sintering method of claim 7, wherein the gas supply device has gas supply holes arranged at predetermined intervals in order to uniformly supply gas to the furnace body.

11. The sintering method of claim 7, wherein the gas supply device, disposed under the setter, serves as a support for the setter and the ceramic molded product.

12. The sintering method of claim 7, further comprising disposing an exhaust pipe at an upper side of the insulating material.
